(19) United States
(12) Patent Application Publication
(10) Pub. No.: US 2010/0245127 A1
(43) Pub. Date: Sep. 30, 2010

(54) Garage parking assistant

(76) Inventor: Vuong Binh Hong, Costa Mesa, CA (US)

Correspondence Address: Vuong Binh Hong, 3132 Coolidge Ave, Costa Mesa, CA, 92626, US

(21) Appl. No.: 12/383,804

(22) Filed: Mar. 30, 2009

(51) Int. Cl. B60Q 1/48

(52) U.S. Cl. 340/932.2

(57) ABSTRACT

The garage parking assistant is an apparatus to help the car driver to park his or her car in a garage equipped with a garage opener which has safety sensors. The garage parking assistant will signal the driver by turning on an LED light when the rear car bumper just passed the safety sensors. At that moment, the driver can apply the brake and car is parked in an optimum position, just inside the garage, safely closest to the garage door.

The garage parking assistant is an apparatus to help the car driver to park his or her car in a garage equipped with a garage opener which has safety sensors. The garage parking assistant will signal the driver when to stop by turning on an LED light just as the rear bumper of his or her car passed the infrared beam of the transmitting safety sensor. At that moment, the driver can apply the brake and car is parked in an optimum position, just inside the garage and safely closest to the garage door.

REFERENCE

| | | |
|---|---|---|
| 7,049,980 | May 23, 2006 | Chemelewski |
| 6,218,962 | Nov. 30, 1999 | Fiene; Dale E |
| 5,945,907 | Aug. 31, 1999 | Yaron, et al. |
| 4,808,997 | Feb. 28, 1989 | Barkley et al. |
| 3,493,925 | February 1970 | Brancale |

US Pat. No. 7,049,980 Chemelewski May 23, 2006, discloses the automobile entry detector for garages designed to assist a motorist with properly positioning a vehicle inside the garage. The device includes a garage door opener control switch, a light transmitter that transmits a beam of light to a light receptor with an LED indicator, a photocell, and an indicator lamp. The LED indicator is extinguished when the beam of light is unbroken, and the photocell relays this information to activate the lamp at the same time as the LED. When the leading edge of a vehicle passes through the light beam, the LED and indicator lamp are illuminated and are only extinguished after the trailing edge of the vehicle has passed through the beam, indicating that the vehicle is properly positioned to allow unobstructed closure of the garage door. This device has the disadvantages of complex and does not work well in bright, sunny days.

U.S. Pat. No. 4,808,997 to George J. Barkley and Roberta Barkley discloses a photoelectric vehicle position indicating device for use in parking and otherwise positioning vehicles. The positioning device includes a photoelectric control unit mounted on an overhead structure and directing a downward beam turning on an alarm signal for a predetermined amount of time when the beam is intercepted. However, the Blakely, et al. '997 device has the disadvantages of working on single car only, audible alarm is an annoyance specially at night and most of all not providing protection of the rear end of the car from the garage door.

U.S. Pat. No. 3,493,925 to Louis Brancale discloses the use of a magnetic proximity switch mounted to the front wall of the garage to light a signal lamp as the vehicle approaches closely to such front wall or to a pylon upon which the magnetic proximity detector is mounted. The Brancale '925 device has the disadvantage of not very accurate and to prevent the owner to install furniture or shelves along the front wall of the garage.

U.S. Pat. No. 6,218,962 B1 to Dale E. Fiene discloses a parking guide for automatic garage door openers that consists of a feature that directs a beam of light onto the front of the hood of the vehicle as it proceeds into the garage. The motorist pulls forward into the garage until the light coincides with a predetermined reference point on the vehicle. The Fiene '962 B1 device has the disadvantages of requirement of modification of the hood of the vehicle with a decal in order for the device to work properly, especially for unaccustomed drivers. If there are multiple cars parking in the garage, it is difficult to define the locations of the decals on the hoods of those cars.

U.S. Pat. No. 5,945,907 to Michael Yaron, Bernard Katz, and Karl E. Geisel discloses an apparatus and methods for parking a vehicle using a position detection sensor. A sensing and indicating device is mounted at a fixed location and determines the distance between the sensor and an approaching vehicle. The sensor provides visual and/or audible indication of the distance between the vehicle and the sensor, allowing the driver to position the car at a certain position. The Yaron, et al. '907 patent is difficult to use and not very accurate. The driver has to make so many calculations and decisions to park the car at proper location.

### BACKGROUND OF THE INVENTION

There is a need to help the driver to park his or her car in a garage, especially a small garage. The driver needs to park the car completely inside the garage so the garage door can be closed and will not hit the car. However, the driver cannot park his or her car too far from the garage door due to limitation of the garage. Parking inside a garage, especially a small garage, requires skills, coordination and time consuming. The present invention provides a simple, inexpensive, easy to use and accurate way of parking in a garage virtually perfect most of the time.

Almost all the garage opener at the present time has safety sensors which will stop the garage door from closing if there is obstruction of the sensor's beam. This is to protect a young child or small pet from getting hurt by the closing garage door when standing below the garage door. However, the garage safety sensors will not protect the car from hit by the garage door if the car is parked in a position in which the rear tires just passes the beam but the rear end is still under the garage door. When the garage door hits the car, there is a mechanism to stop and then to open the garage door. However, the car is already damaged. The driver might try to park the car father inside to avoid that situation but the garage depth is limited especially for a small garage. In addition, the driver needs to walk in front of the car so the closer the car parked safely next to the garage door the better.

There are many devices to help the driver to park his or her car in a good position but they have some drawbacks such as expensive, complicated to use or not very accurate. The safety sensors are a good candidate for a garage parking guidance but there is a maximum height above the ground they can be located and thus they cannot detect the rear bumper of the car. The present invention solves those issues by providing a garage parking assistant accurate, low cost, simple to use, similar to safety sensors but it can detect the rear bumper of the parking car.

When the rear bumper of the car just passed the transmitter safety sensor beam, a signal light will turn on and signal the driver to stop the car. The car will be at optimum position: closest to the garage door and maximum distance from the car front to the inside wall. The present invention will work with different bumpers heights of different cars without any modification or reset up requirements.

The present invention can be built as a stand alone unit or incorporated into a garage opener.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a garage parking assistant system including a 5 Volt DC regulation circuit, an infrared detecting circuit and a control and display circuit according to the present invention.

FIG. 2 shows the 5 Volt DC regulation circuit according to the present invention.

FIG. 3 shows the block diagram of the infrared detection circuit according to the present invention.

FIG. 4 shows the block diagram of the control and display circuit according to the present invention.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

The present invention provides a simple but effective apparatus and method to assist a driver to park his or her car at the optimum location inside the garage.

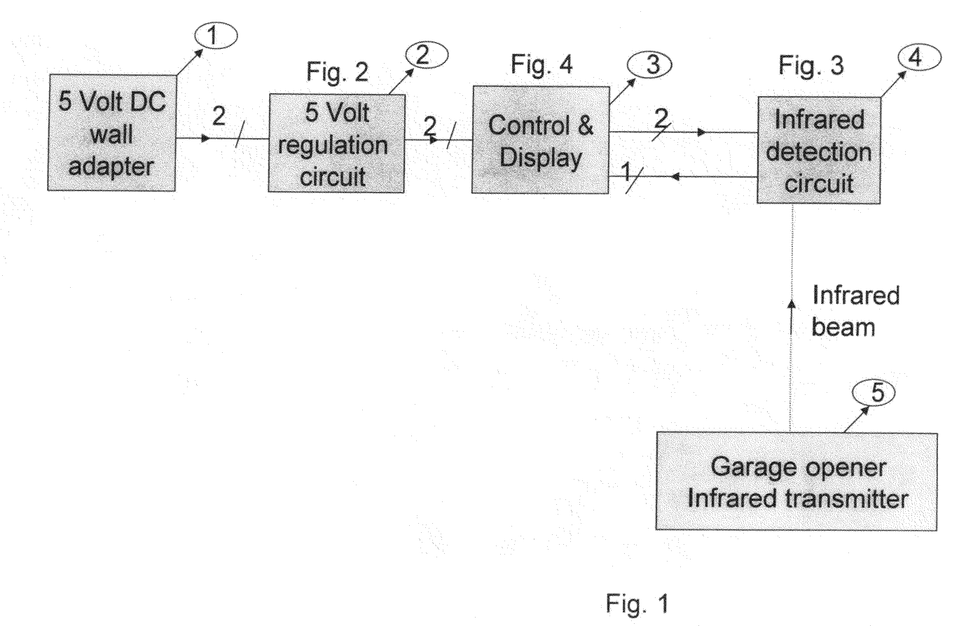

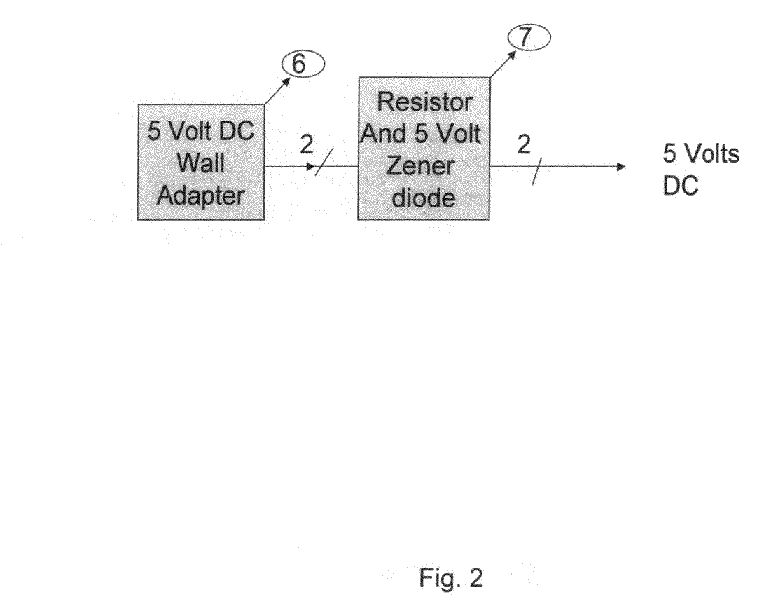

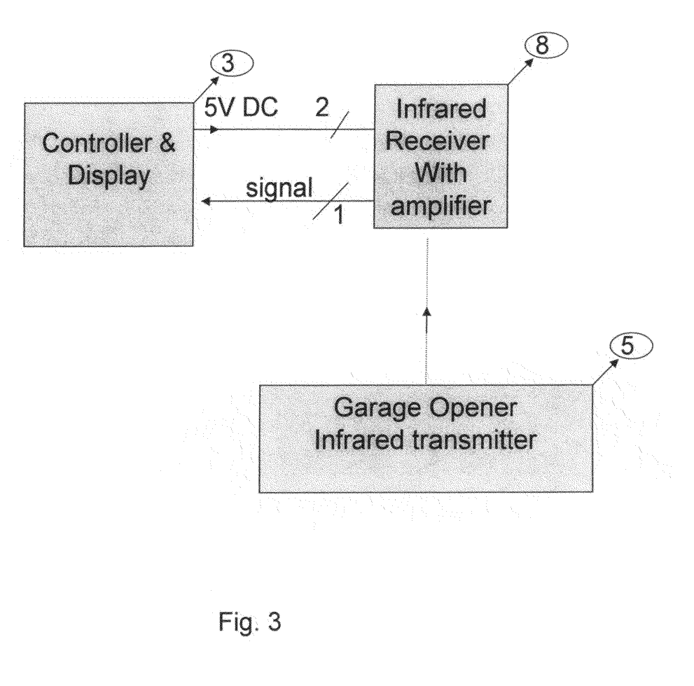

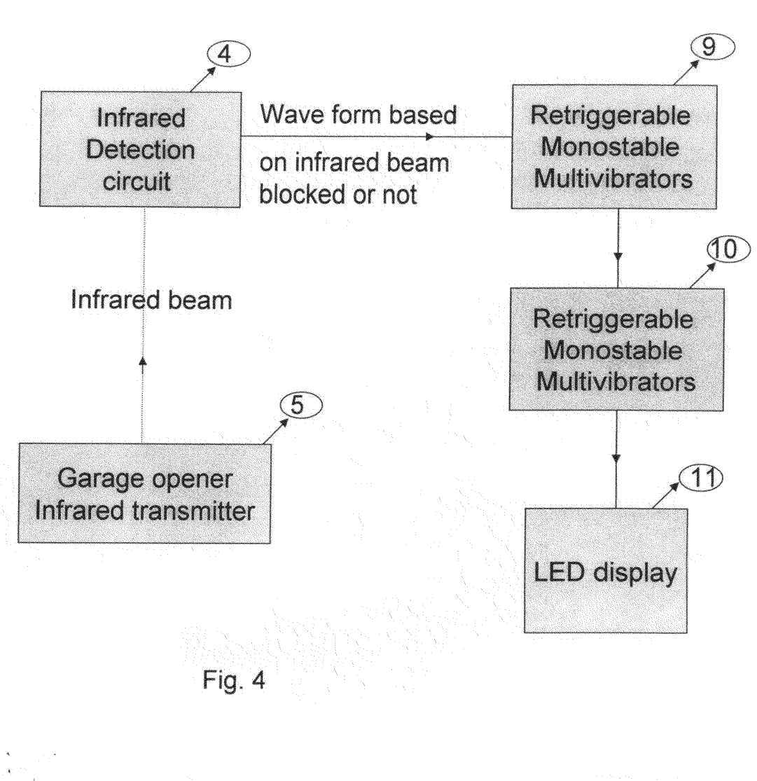

From FIG. 1, an unregulated 5 Volt AC/DC wall adapter 1 provide the 5 volt regulation circuit 2 with a DC Voltage which varies from 5 Volts to 9 Volts unregulated which can be used to energize the present invention by connecting through the conductors 1-2. The 5 Volt regulation circuit 2 shown in FIG. 2 converts the unregulated 5 Volt Direct Current (DC) into a regulated 5 Volt DC which provides the power for all components of the present invention. The Controller and Display Circuit 3 shown in FIG. 3 provides 5 Volts power to the Infrared Detection Circuit 4 shown in FIG. 3 through the conductors 3-4 and receives the wave form signal from the infrared detection circuit 4 through the conductor 4-3. If the infrared beam from the garage opener infrared transmitter 5 is blocked, the wave form signal in the conductor 4-3 will be turn off. When the infrared beam is blocked and then unblocked, the control and display 3 shown in FIG. 4 will turn on the LED built in to the Control and display module for a predetermined period of time and then turns the LED off. This event happens when the car rear bumper just passed the infrared transmitter of the safety sensors. Thus the driver just needs to stop the car when the LED of the control and display just turns on. The car will be parked with the rear end of the car closest to the infrared beam and the front end of the car is farthest from the inside wall. The LED will turn off after a certain amount of time (around 10 seconds) to conserve energy and is ready for the next parking.

FIG. 2 shows the 5 Volt DC regulation circuit to convert the unregulated 5 Volt DC to regulated 5 Volt DC. A series resistor and a parallel 5 Volt Zener diode will regulate and keep the power supplied for the present invention at constant 5 Volts DC.

FIG. 3 shows the infrared detection circuit. This circuit comprises an infrared receiver with amplifier 8 such as, but not limited to, PAN4602M. This infrared receiver with amplifier 8 is placed above the infrared receiver of the safety sensor and above the rear bumper of the parking car. The vertical distance from the infrared receiver depends on the height of the rear bumper of the parking car. The output of the infrared receiver with amplifier 8 output is connected to the control and display circuit 3 shown in FIG. 4 which is placed where the driver can see the LED.

FIG. 4 shows the control and display 3. This circuit comprises of two retriggerable monostable Multivibrators (RMM) 9 and 10, a LED display, a PNP transistor and appropriate resistors and capacitors. The output of the RMM 9 connects to the input of the RMM 10. The RMM 9 receives the wave form from the infrared receiver 8. If the wave form exists, the output of the RMM 9 will be a continuous high signal. In turn, the output of the RMM 10 will be low and the LED 11 will be turn off. When the wave form does not exists (the infrared beam is blocked), the output of the RMM 9 will be a continuous low signal. In turn, the output of the RMM 10 will still be low and the LED 11 will be turn off. When the infrared beam is blocked and then unblocked, the output of the Multivibrators 9 will change from high state to low state. Thus the output of the RMM 10 will be high for a predetermined period of time and then will be turned off depend on the values of the resistor and capacitor and the LED 11 will be turn on for that period of time. When the infrared beam is unblocked and then blocked, the output of the RMM 9 will change from high state to low state and the output of the RMM 10 will not change. This sequence of events will turn on the LED when the car rear end unblocks the infrared beam. The driver knows exactly when the rear bumper just passed the infrared beam and thus can stop the car at the optimum location (safely nearest to the garage door)

What is claim is:

1) A garage parking circuit: a safety beam sensor circuit assists the driver to park the car in the garage by turning on a LED signal light when the car rear bumper just passed the safety beam.

2) The garage parking circuit of claim 1, wherein the 5 Volt DC regulation circuit regulates the unregulated 5 Volt DC from the 5 Volt DC wall adapter.

3) The garage parking circuit of claim 2, wherein a 0.5 Watt, 33 Ohms resistor and a 5 Volt Zener diode will convert the 5-9 Volt DC unregulated voltage to 5 Volt DC source to power the components of the present invention.

4) The garage parking circuit of claim 1, wherein the infrared detection circuit comprises of an infrared receiver with amplifier such as but not limited to PAN4602M to receive the weak infrared signal from the transferring safety sensor of the garage opener (the infrared beam is weak because the receiver will be put a couple of feet above the receiving safety sensor, not direct in front of the transmitting safety sensor.) The signal will be amplified and then sent to the Control and display unit. When the infrared beam is unblocked, the output of the infrared receiver will be in wave form. When the infrared beam is blocked, the output of the infrared receiver will be constant high.

5) The garage parking circuit of claim 1, wherein the control and display comprises of a dual retriggerable monostable Multivibrators (RMM), three red LED's, one pnp transistor 3904 and several resistors and capacitors.

6) The garage parking circuit of claim 5, wherein the output of the first RMM will be at state high or low when the beam is unblocked or blocked, respectably and the output of the second RMM is low in both conditions (except when the beam changes from blocked condition to unblocked.) When the infrared beam changes from blocked to unblocked condition, the output of the first RMM changes from high to low and in turn, the output of the second RMM turns on for a period of time dependent on the values of the resistor and capacitor configured with the second Multivibrators. When the infrared beam changes states from unblocked to blocked, the first RMM changes from low to high and the second RMM will not change state.

7) The garage parking circuit of claim 5, wherein the LED will be turn on when the output of the second RMM is on. This signals the driver that the infrared beam just changes from blocked condition to unblocked condition or the car just passed the infrared beam. The driver thus should stop the car at this moment to park the car at the optimum location, nearest to the garage door.
